(19) United States
(12) Patent Application Publication
(10) Pub. No.: US 2005/0230987 A1
(43) Pub. Date: Oct. 20, 2005

(54) Roast lifter

(76) Inventor: Steven H. Bright, Oakville (CA)

Correspondence Address: John Jeffrey;c/o Dennison Associates, Suite 301, 133 Richmond Street West, Toronto, ON, M5H 2L7, CA

(21) Appl. No.: 10/823,728

(22) Filed: Apr. 14, 2004

(51) Int. Cl. A47J 43/28

(52) U.S. Cl. 294/152

(57) ABSTRACT

A roast lifter comprised entirely of string or cord material is used to facilitate the lifting of various roasted meats and poultry and the like from a roasting pan. The roast lifter consists of a net of interwoven string or cord, and a pair of string or cord handles attached to the interwoven net. The roast lifter is placed within the roasting pan and the roast is placed in the center of the woven mesh net and cooked in the conventional manner. The twine handles are grasped with one or two hands to lift the roast out of the roasting pan to the cutting or serving surface.

### FIELD OF THE INVENTION

The present invention relates to a lifter for use in roasting various pieces of meats and poultry and the like, and more particularly, relates to a lifter formed entirely from string material.

### BACKGROUND OF THE INVENTION

Different roast lifters have been developed for lifting a roast from the roasting pan to a cutting or serving surface. Traditional roast lifters are generally made of metal, such as stainless steel. One type of metal roast lifter comprises devices used to pierce the roasting meat or poultry, such as large forks. These lifters are problematic because they create unappealing holes in the roasting meat or poultry, which affect the appearance and satisfaction of the roast. A second type of metal roast lifter comprises a support rack with handles. However, these roast lifters become very hot and require the use of oven mitts or the like.

Attempts have been made to create a roast lifter that overcomes the problems with the traditional roast lifters. U.S. Pat. No. 2,514,098 discloses a sling composed of an endless loop of cord or string, whereby metal struts or spacer members are used to support and lift the roast. However, as the string or cord is held within notches in the metal struts or spacer members, the metal struts or spacer members are not securely attached to the string. This creates a dangerous situation as the roast is precariously supported when lifted using this device.

U.S. Pat. No. 4,942,809 discloses a plastic mesh jacket for use in cooking large pieces of meat, turkeys, chickens, roast and the like. The jacket substantially encloses the piece of meat. However, the jacket must be expanded when placing the roast within it, and the jacket clings to the roast during cooking; thereby, disrupting the placement of seasonings and spices on the outer surface of the meat or poultry.

### SUMMARY OF THE INVENTION

It is an object of the invention to provide a roast lifter which is strong, yet inexpensive to manufacture.

A further object of this invention is to provide a roast lifter constructed entirely of string or cord which can easily and quickly lift a roasted meat or poultry from the roasting pan, can securely support the roasted meat or poultry, can allow the fat and drippings to remain in the roasting pan, allows the roast to cook and brown in the conventional manner, and does not affect the appearance or taste of the roasted meat or poultry.

In one aspect of this invention, there is provided a roast lifter comprised entirely of string or cord, which includes a support platform of woven string or cord, and string or cord handles attached at the ends of the support platform. During use, the roast lifter is placed in the roasting pan along the bottom of the roasting pan, and the meat or poulty to be cooked is placed into the roasting pan and centered on top of the support platform of the roast lifter. The handles of the roast lifter are used to lift the roasted meat or poultry, in combination with the support platform of the roast lifter, from the roasting pan. The roast lifter allows the roast to be held securely above the pan to allow the drippings to stay within the roasting pan.

By another aspect of this invention, there is provided a method of making a woven string or cord roast lifter comprising a support platform, and handles at opposite ends of the support platform.

### BRIEF DESCRIPTION OF THE DRAWINGS

Preferred embodiments of the invention are shown in the drawings, wherein:

FIG. 1 is a perspective view of the roast lifter in accordance with the principles of the present invention.

FIG. 2 is an enlarged view of a single knot before it is pulled tight, showing the method of manufacture.

FIG. 3 is a perspective view of the roast lifter illustrating its relation with a roasting pan.

FIG. 4 is a perspective view of the roast lifter illustrating a roast disposed thereupon.

### DETAILED DESCRIPTION OF THE PREFERRED EMBODIMENTS

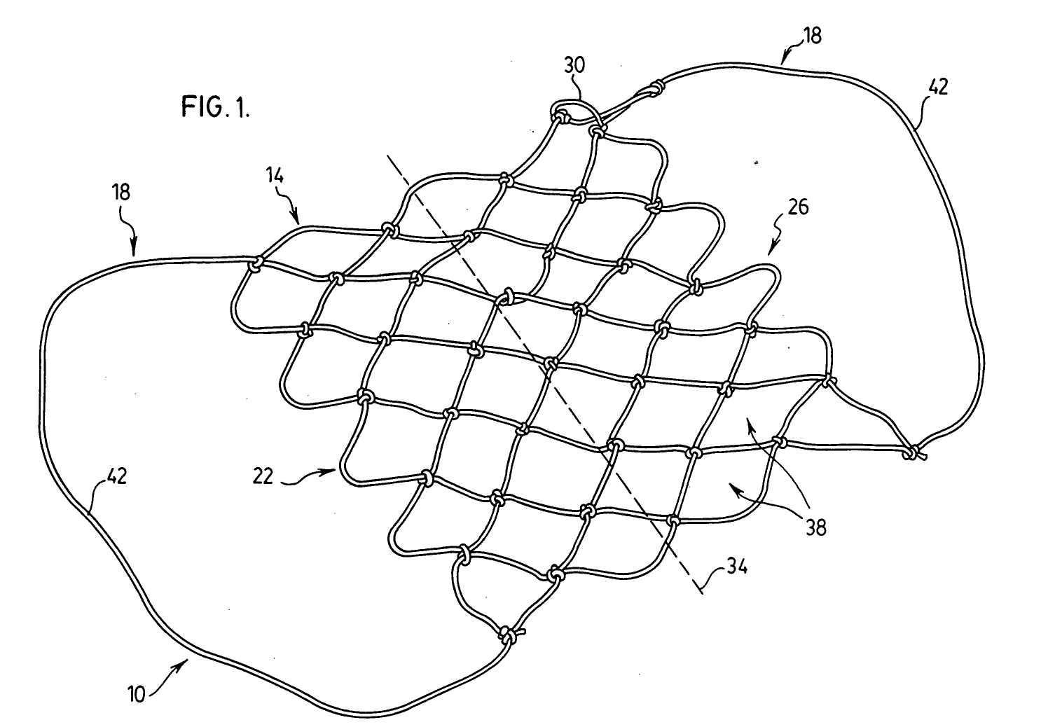

As shown in FIG. 1, a roast lifter 10 includes a support platform 14, and handles 18, which is attached at the first side 22 and second side 26 of support platform 14. The roast lifter 10 is formed with string or cord material 30, such as twine and preferably butcher's twine. The string or cord material 30 must be of sufficient strength to withstand the weight of the roasting meat or poultry.

Support platform 14 extends along a longitudinal axis 34 between the first side 22 and second side 26, and has one or at least one cord 30 intertwined to define a net having a plurality of apertures 38. In one preferred embodiment of the invention, the support platform 14 has a generally quadrilateral shape. Support platform 14 is dimensioned to provide accomodation for different sized meats, poultry cuts, and roasts.

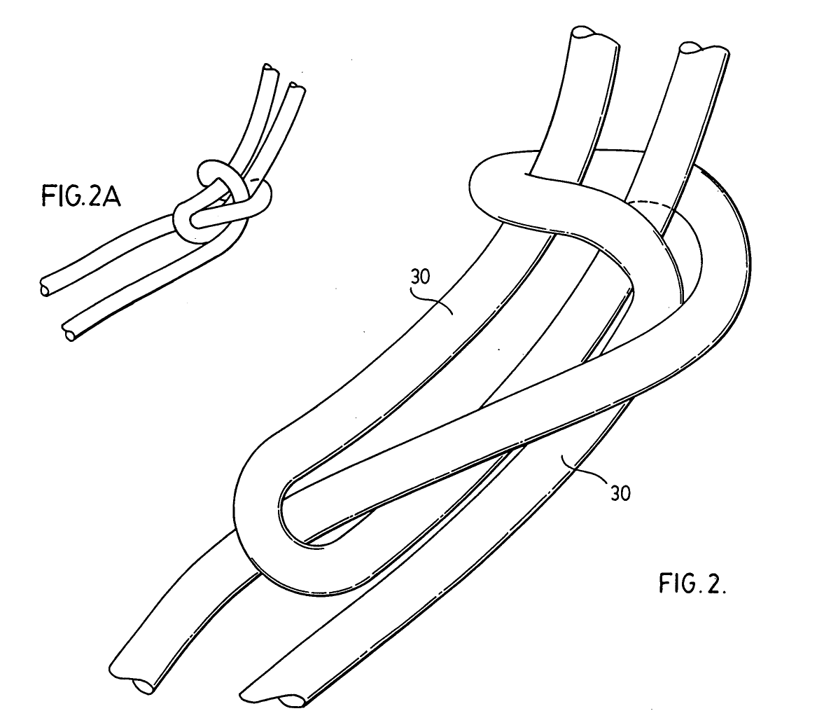

FIG. 2 illustrates one preferred method of interwining the cord 30. In this preferred method, the cord 30 is intertwined using conventional tools for creating a conventional netting, such as fish netting.

In a preferred embodiment of the invention, the roast lifter 10 is comprised of two handles 18 located on opposite sides of the support platform 14. The handles 18 are formed using string or cord material 30. In one embodiment of the invention, the handles 18 are formed from one or at least one cord 30 from the support platform 14. In another embodiment of the invention, the handles 18 are formed from one or at least one separate piece of cord 42. The ends of the first handle cord 42 is attached or knotted to the first side 22 of the support platform 14. Preferably, the ends of the handle cord 42 are attached or knotted at approximately the distal ends of the first side 22 of the support platform 14. Similarly, the second handle cord 42 is attached or knotted to the second side 26 of the support platform 14 in a similar manner.

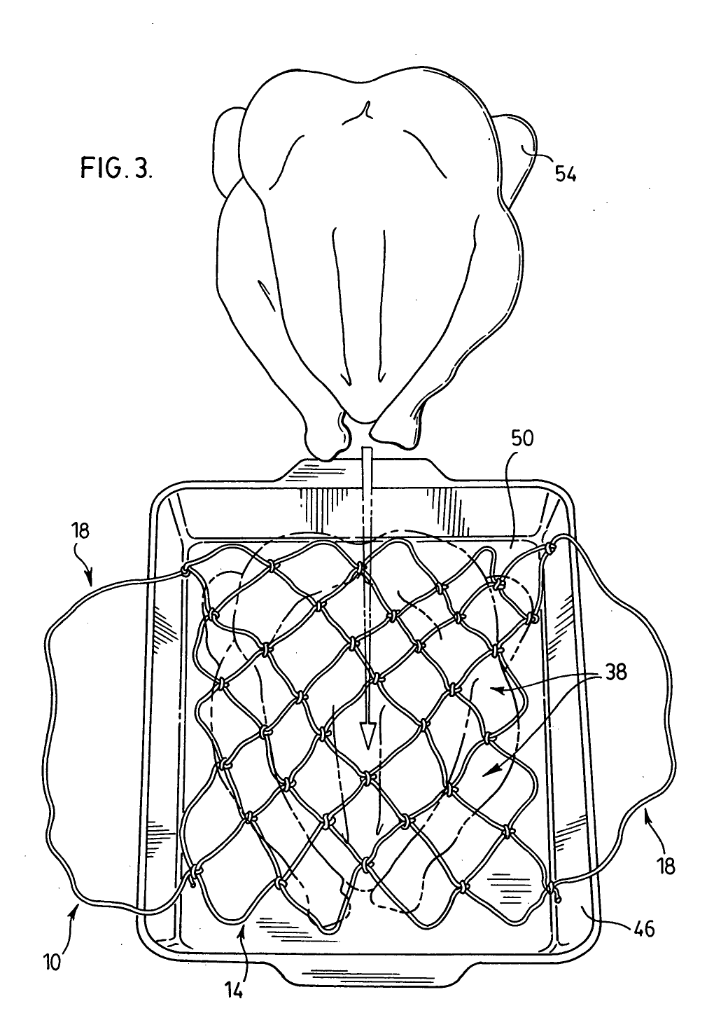

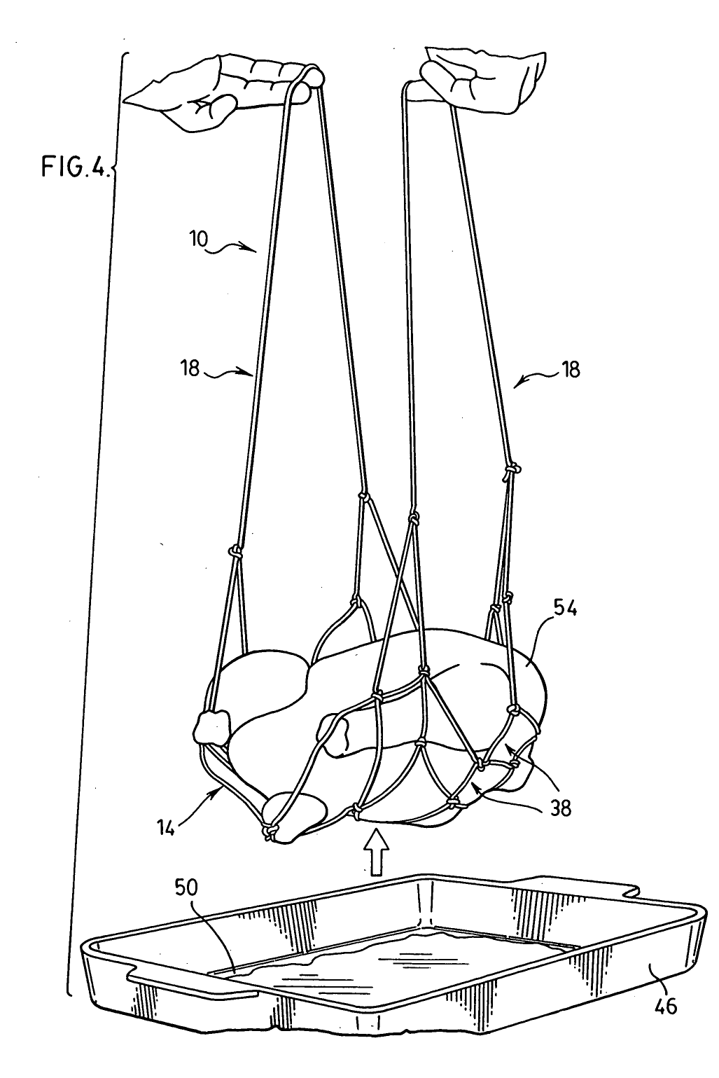

FIGS. 3 and 4 illustrate the use of the roast lifter 10. The roast lifter 10 is placed within a roasting pan 46, and the support platform 14 is centered within the bottom 50 of the roasting pan 46. The meat or poultry 54 to be cooked is positioned in the center of the support platform 14 of the roast lifter 10. After cooking and browning the meat or poultry 54 in the conventional manner, the handles 18 of the roast lifter 10 are grasped in one or two hands to lift the meat or poultry 54 from the roasting pan 46 to a cutting or serving surface. The apertures 38 allow the fat and drippings from the meat or poultry 54 to drip and remain in the roasting pan 46.

Although various preferred embodiments of the present invention have been described herein in detail, it will be appreciated by those skilled in the art, that variations may be made thereto without departing from the spirit of the invention or the scope of the appended claims.

1. (canceled)

2. (canceled)

3. (canceled)

4. A roast lifter for use in cooking and moving meat or poultry comprising a body for holding and supporting the meat or poultry, and
at least two handles attached to opposing peripheral edges of the body for lifting the combination of the body and the meat or poultry, wherein
the body and the handles are comprised entirely of one interwoven string or cord interwoven into a net with a plurality of apertures to form the body and loops at opposing peripheral edges of the body to form the handles.

5. A roast lifter according to claim 4 wherein the string or cord material is butcher's twine.

6. A method for producing a roast lifter comprised of string or cord comprising the steps of interweaving a continuous string or cord to form a net conforming to the size of the meat or poultry, and
at least two handles attached to opposing peripheral edges of the net.

7. (canceled)

8. A method for producing a roast lifter according to claim 6 and 7 wherein the string or cord is butcher's twine.
